(19) United States
(12) Patent Application Publication
(10) Pub. No.: US 2009/0276846 A1
(43) Pub. Date: Nov. 5, 2009

(54) Multi-Function Apparatus and Method of Restricting Use of Multi-Function Apparatus

(75) Inventor: Satoshi KOTAKA, Azumino-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/427,556

(22) Filed: Apr. 21, 2009

(30) Foreign Application Priority Data
May 1, 2008 (JP) 2008-119928

(51) Int. Cl. G06F 21/00

(52) U.S. Cl. 726/17

(57) ABSTRACT

A multi-function apparatus which has plural functions and is used by direct use through an operation panel and remote use through a communication network, the multi-function apparatus includes: a use setting unit which sets use or non-use of at least some functions of the multi-function apparatus in accordance with a user attribute indicating a direct-use user or a remote-use user; and a use restriction unit which permits a user desiring to use the at least some functions to use the at least some functions on condition that the user attribute of the user is set to be usable by the use setting unit.

### BACKGROUND

1. Technical Field

The invention relates to a multi-function apparatus having plural functions.

2. Related Art

In the past, as a multi-function apparatus capable of executing plural functions such as an image forming function, an image reading function, and a fax communication function, there was known a multi-function apparatus which has a use restriction function of permitting only qualified users to use some functions of the multi-function apparatus in terms of security (see JP-A-2006-215770).

A multi-function apparatus having the use restriction function is capable of individually setting usable functions and unusable functions in accordance with qualified users.

The use restriction function of the known multi-function apparatus enables users to use functions of use-restricted units on condition that user authentication succeeds without distinguishing users directly using the functions through an operation panel from users using the functions through a communication network.

For example, in the case of a direct-use user, user authentication success determined on the basis of authentication information acquired through a card reader or the like is set as a condition for using the functions of the use-restricted units. In the case of a remote-use user, user authentication success determined on the basis of authentication information transmitted from a terminal device to the multi-function apparatus is set as a condition for using the functions of the use-restricted units.

For that reason, in order to permit the functions of the use-restricted units to be used without executing user authentication of the remote-use user by the multi-function apparatus, functions to be used for the remote-use user need to be individually excluded from the functions of the use-restricted units (used without user authentication).

On the contrary, in order not permit the functions of use-restricted units to be used regardless of success in user authentication of the remote-use user by the multi-function apparatus, functions to be used for the remote-use user need to be individually set as unusable functions in accordance with the qualified users.

A work of individually setting the unusable functions is troublesome for an administrator that executes setting. Moreover, it is easy to erroneously set specific functions or the qualified users.

### SUMMARY

An advantage of some aspects of the invention is that it provides a new technique capable of flexibly and simply setting use restriction for remote-use users in a multi-function apparatus having a use restriction function.

According to an aspect of the invention, there is provided a multi-function apparatus which has plural functions and is used by direct use through an operation panel and remote use through a communication network, the multi-function apparatus including: a use setting unit which sets use or non-use of at least one of functions which the multi-function apparatus has in accordance with a user attribute indicating a direct-use user or a remote-use user; and a use restriction unit which permits a user desiring to use the at least one of the functions to use the at least one of the functions on condition that the user attribute of the user is set to be usable by the use setting unit.

With such a configuration, when it is desired that the at least one of the functions of the multi-function apparatus cannot be used by the remote-use user, this operation can be easily realized by configuring the at least one of the functions of the multi-function apparatus to be used only when the user attribute indicates the direct-use user.

Alternatively, when it is desired that the at least one of the functions of the multi-function apparatus can be used by the remote-use user, this operation can be easily realized by configuring the at least one of the functions of the multi-function apparatus to be used when the user attribute indicates the remote-use user.

The multifunction apparatus according to this aspect of the invention further includes an authentication success determining unit which determines whether authentication succeeds on the basis of authentication information acquired from the user. The use setting unit selects one of plural patterns including a first pattern used to permit the at least one of the functions to be used only when the user attribute indicates the direct-use user and the authentication success determining unit determines that the authentication succeeds, a second pattern used to permit the at least one of the functions to be used when the user attribute indicates the direct-use user and the authentication success determining unit determines that the authentication succeeds and when the user attribute indicates the remote-use user, and a third pattern used to permit the at least some functions to be used when the user attribute indicates the direct-use user or the remote-use user.

With such a configuration, when it is desired that the at least one of functions of the multi-function apparatus are permitted to be used by the direct-use user in a case where the authentication succeeds and it is also desired that the at least one of the functions of multi-function apparatus are not permitted be used for the remote-use user regardless of authentication success or failure, this configuration can be easily realized by setting the at least one of the functions of the multi-function apparatus so as to be used (that is, by selecting the first pattern) only when the user attribute indicates the direct-use user and the authentication success determining unit determines that the authentication succeeds.

When it is desired that the use of the at least one of the functions of the multi-function apparatus are permitted to the direct-use user in the case where the authentication succeeds and it is also desired that the at least one of the functions of the multi-function apparatus are permitted to be used by the remote-use user without executing the user authentication by the multi-function apparatus, these units can be easily realized by configuring the functions of the use-restricted functions so as to be used (that is, by selecting the second pattern) when the user attribute indicates the direct-use user and the authentication success determining unit determines the authentication success and when the user attribute indicates the remote-use user.

In the multi-function apparatus according to this aspect of the invention, the use setting unit may display options used to select one of the plural patterns on a display unit of the multi-function apparatus or a display unit of a terminal device connected to the multi-function apparatus through the communication network, and may select one of the plural patterns on the basis of operation of the user.

According to another aspect of the invention, there is provided a method of restricting use of a multi-function apparatus which has plural functions and is used by direct use through an operation panel and remote use through a communication network, the method comprising: setting use or non-use of at least one of the functions which the multi-function apparatus has in accordance with a user attribute indicating a direct-use user or a remote-use user; and permitting a user desiring to use the at least one of the functions to use the at least one of the functions on condition that the user attribute of the user is set to be usable in the setting of the use or the non-use.

The method according to this aspect of the invention can be realized by a CPU included in the multi-function apparatus. However, a program capable of executing the method can be installed or loaded through various media such as a CD-ROM, a magnetic disk, a semiconductor memory, and a communication network.

In the specification, units include units realized by hardware, units realized by software, and units realized by hardware and software. In addition, one unit may be realized by two or more hardware units and two or more units may be realized by one hardware unit.

According to these aspects of the invention, there is provided a new technique capable of setting use restriction for the remote use user flexibly and simply in the multi-function apparatus having the use restriction function.

### BRIEF DESCRIPTION OF THE DRAWINGS

The invention will be described with reference to the accompanying drawings, wherein like numbers reference like elements.

FIG. 1 is a block diagram illustrating the overall configuration of an information processing system.

FIG. 2 is a diagram illustrating an example of function units included in a control unit.

FIGS. 3A to 3C are diagrams illustrating use/non-use patterns which can be selected by a use setting unit.

FIG. 4 is a diagram illustrating an example of a use/non-use pattern selection screen displayed in a setting change mode.

FIG. 5 is a flowchart illustrating a process when a multi-function apparatus is activated.

FIG. 6 is a flowchart illustrating a process when a use restriction function of the multi-function apparatus is valid.

FIG. 7 is a flowchart illustrating a process when the use restriction function of the multi-function apparatus is valid.

FIG. 8 is a flowchart illustrating a job control process of the multi-function apparatus.

FIG. 9 is a diagram illustrating an example of a basic function menu screen.

FIGS. 10A to 10C are diagrams illustrating use or non-use of functions of use-restricted units when each use/non-use pattern is selected.

### DESCRIPTION OF EXEMPLARY EMBODIMENTS

### First Embodiment

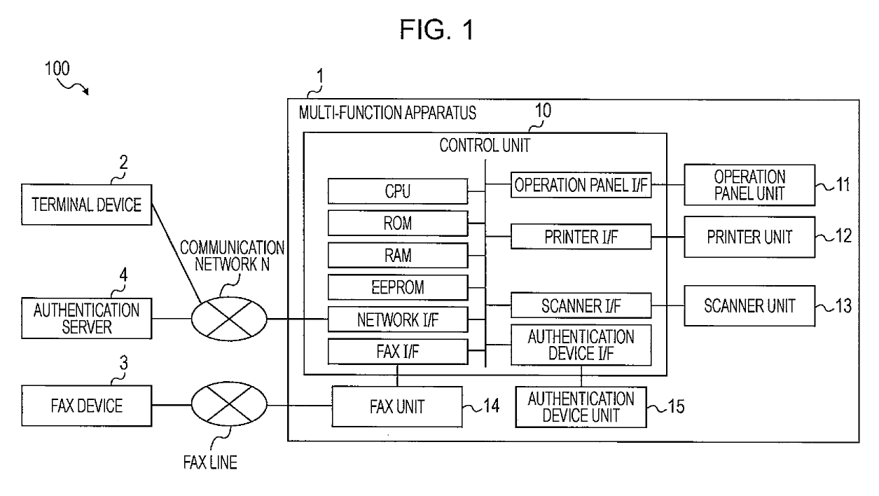

FIG. 1 is a block diagram illustrating the overall configuration of an information processing system 100 including a multi-function apparatus 1 according to an embodiment of the invention.

As shown in FIG. 1, the information process system 100 includes the multi-function apparatus 1 which can make direct use trough an operation panel and make remote use through a communication network N, a terminal device 2 which is connected to the multi-function apparatus 1 through the communication network N to make remote use of the multi-function apparatus 1, a fax device 3 which is connected to the multi-function apparatus 1 through a fax line to transmit and receive fax data to and from the multi-function apparatus 1, and an authentication server 4 which is connected to the multi-function apparatus 1 through the communication network N to execute an authentication process.

In FIG. 1, one multi-function apparatus 1, one terminal device 2, one fax device 3, one authentication server 4 are illustrated. However, the information processing system 100 may include one or more multi-function peripheries, one or more terminal devices, one or more fax devices, and one or more authentication servers depending on a design thereof. In addition, the communication network N may be configured by an LAN, the Internet, a dedicated line, or a packet communication network or a combination thereof, or by both a wired-line network and a wireless line network.

The multi-function apparatus 1 includes hardware units such as a control unit 10, an operation panel unit 11, a printer unit 12, a scanner unit 13, a fax communication unit 14, and an authentication device unit 15.

The configuration of each hardware unit is the same as that of a known multi-function apparatus in principle. For example, the control unit 10 include a CPU, a memory (a ROM, a RAM, an EEPROM, or the like), an operation panel I/F, a printer I/F, a scanner I/F, a fax I/F, a network I/F, and an authentication device I/F, like a known control unit. As the authentication device unit 15, a card reader unit can be used, for example.

The CPU of the control unit 10 executes programs stored in the memory and controls the hardware units to realize function units of the multi-function apparatus 1.

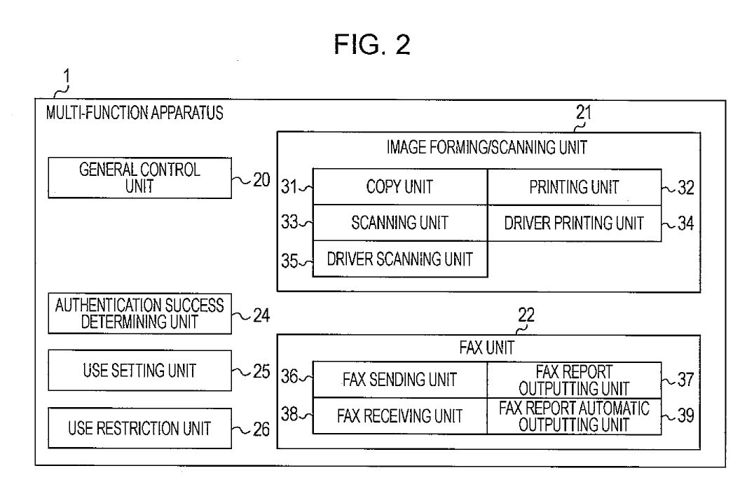

Representative function units of the multi-function apparatus 1 are illustrated in FIG. 2. As shown in FIG. 2, the multi-function apparatus 1 includes a general control unit 20 as a function of controlling the whole operations of the multi-function apparatus 1. As basic functions, function units such as an image forming/reading unit 21 and a fax unit 22 are included.

The image forming/reading unit 21 includes a copy unit 31, a printing unit 32, and a scanning unit 33 as a function (direct use function) to be directly used. In addition, the image forming/reading unit 21 also includes a driver printing unit 34 and a driver scanning unit 35 as a function (remote use function) to be remotely used.

The fax unit 22 includes a fax sending unit 36 and a fax report outputting unit 37 as the direct use function. In addition, the fax unit 22 also includes a fax receiving unit 38 receiving fax data from an external fax device through the fax line and outputting the received fax data and a fax report automatic outputting unit 39 automatically outputting a fax report.

The above units are the same as those included in the known multi-function apparatus. For example, under the control of the general control unit 20, the printing unit 32 performs a printing process by controlling the printer unit 12 through the printer I/F on the basis of a print job spooled in a spool buffer by operation of the operation panel unit 11. In addition, under the control of the general control unit 20, the driver printing unit 34 executes a printing process by controlling the printer unit 12 through the printer I/F on the basis of a print job transmitted from the terminal device 2 and spooled in the spool buffer.

The multi-function apparatus 1 includes, as use restriction functions, an authentication success determining unit 24 which determines whether authentication succeeds on the basis of authentication information acquired from a user by use of the authentication device unit 15, a use setting unit 25 which sets whether to use functions of use-restricted units in accordance with a user attribute indicating a direct-use user or a remote-use user, and a use restriction unit 26 which permits using the functions of the use-restricted units on condition (necessary condition) that the user attribute of a user desiring to use the functions of the use-restricted units is set to be used by the use setting unit 25.

Which function of the multi-function apparatus 1 is set to the function of the use-restricted unit is determined in accordance with a design. In this embodiment, the copy unit 31, the printing unit 32, the scanning unit 33, the driver printing unit 34, the driver scanning unit 35, the fax sending unit 36, the fax report outputting unit 37 are set as the use-restricted units. The fax receiving unit 38 and the fax report automatic outputting unit 39 are not set to the use-restricted units.

In the multi-function apparatus 1 according to this embodiment, use or non-use of the function of the use-restricted unit is not set for the function of every use-restricted unit or every user, like the known example, but the function of the use-restricted unit is set to be used or not to be used depending on the user attribute indicating the direct-use user or the remote-use user.

Specifically, the use setting unit 25 is configured to select one of plural use/non-use patterns. In each of the use/non-use patterns, whether the function of the use-restricted unit is used is determined in accordance with a combination of the user attribute indicating the direct-use user or the remote-use user and a result obtained by determining authentication success or authentication failure by the authentication success determining unit 24.

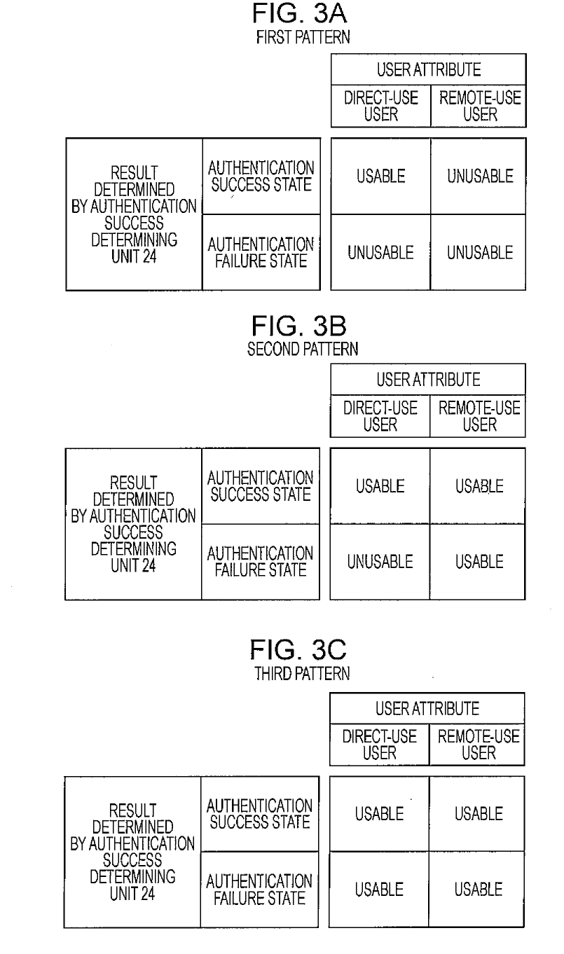

FIGS. 3A to 3C show the use/non-use patterns which can be selected by the use setting unit 25. In this embodiment, as shown in FIGS. 3A to 3C, the use setting unit 25 can select three use/non-use patterns, that is, a first pattern (see FIG. 3A) used to permit the functions of the use-restricted units to be used only when the user attribute indicates the direct-use user and the authentication success determining unit 24 determines authentication success, a second pattern (see FIG. 3B) to permit the functions of the use-restricted units to be used when the user attribute indicates the direct-use user and the authentication success determining unit 24 determines authentication success and when the user attribute indicates the remote-use user, and a third pattern (see FIG. 3C) used to permit the functions of the use-restricted units to be used when the user attribute indicates the direct-use user or the remote-use user. A table representing regulation details of each of the use/non-use patterns shown in FIGS. 3A to 3C is stored as information on the use/non-use pattern in the ROM of the multi-function apparatus 1 in advance.

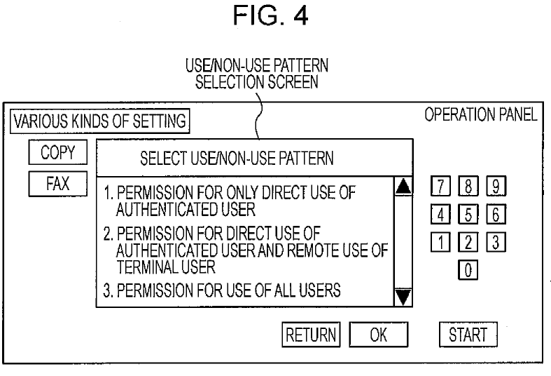

In a setting change mode, the use setting unit 25 selects one of the first to third patterns on the basis of information input from an administrator to set the use or the non-use of the functions of the use-restricted units. It is preferable that an operation for switch to the setting change mode includes an operation executed only by the administrator, for example, an administrator password inputting operation. FIG. 4 schematically illustrates an example of an operation panel on which a use/non-use pattern selection screen to be shown in the setting change mode is displayed. In the drawing, three options, that is, “permission for only direct use of authenticated user”, “permission for direct use of authenticated user and remote use of terminal user”, and “permission for use of all users” correspond to the first pattern, the second pattern, and the third pattern, respectively.

The use setting unit 25 stores the information on the set use/non-use pattern in the RAM and in a non-volatile memory such as the EEPROM at predetermined timing (for example, at the time of power-off). In this way, the information on the set use/non-use pattern is stored, after the multi-function apparatus 1 is turned off.

The terminal device 2, the fax device 3, and the authentication server 4 included in the information processing system 100 have all the same configuration and functions as those of a known information processing system. For example, the terminal device 2 has a log-in function and a user (a user succeeds in user authentication in the terminal device 2) logging in the terminal device 2 is configured to use the multi-function apparatus 1 through the communication network N. For example, the authentication server 4 executes an authentication process on the basis of an authentication request transmitted from the multi-function apparatus 1 and has a function of replying information on authentication success or failure, as a result of the authentication process, to the multi-function apparatus 1.

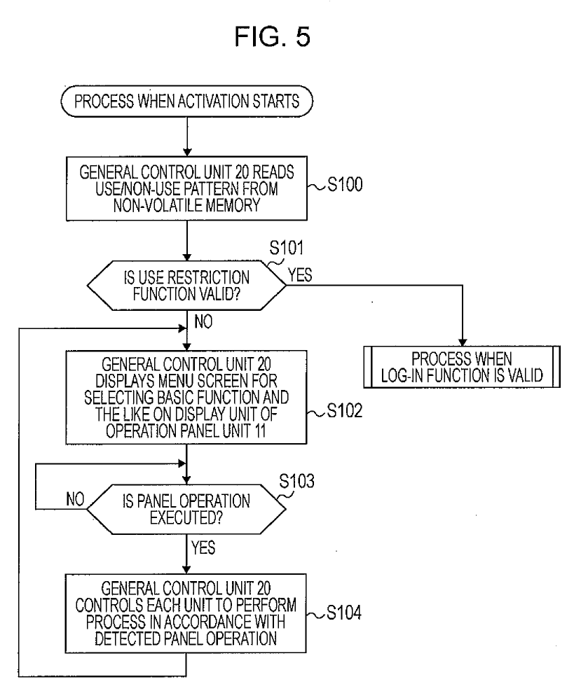

Hereinafter, various processes of the multi-function apparatus 1 will be described with reference to the flowcharts shown in FIGS. 5 to 8. In the specification, the processes (including partial processes to which reference numerals are not given) shown in the flowcharts may be arbitrarily changed in sequence or executed in a parallel manner to the extent that the processes are not contradictory to each other.

### Processes When Activation Starts

The flowchart shown in FIG. 5 describes a process when the multi-function apparatus 1 is activated.

When the multi-function apparatus 1 is turned on, the general control unit 20 reads the use/non-use pattern set by the use setting unit 25 from the non-volatile memory, and stores the read use/non-use pattern in the RAM (S100).

Subsequently, the general control unit 20 determines whether the use restriction function is valid or invalid on the basis of the read use/non-use pattern (S101).

Specifically, when the use/non-use pattern is the first pattern or the second pattern, the general control unit 20 determines that the restriction function is valid. Alternatively, when the use/non-use pattern is the third pattern, the general control unit 20 determines that the use/non-use pattern is invalid.

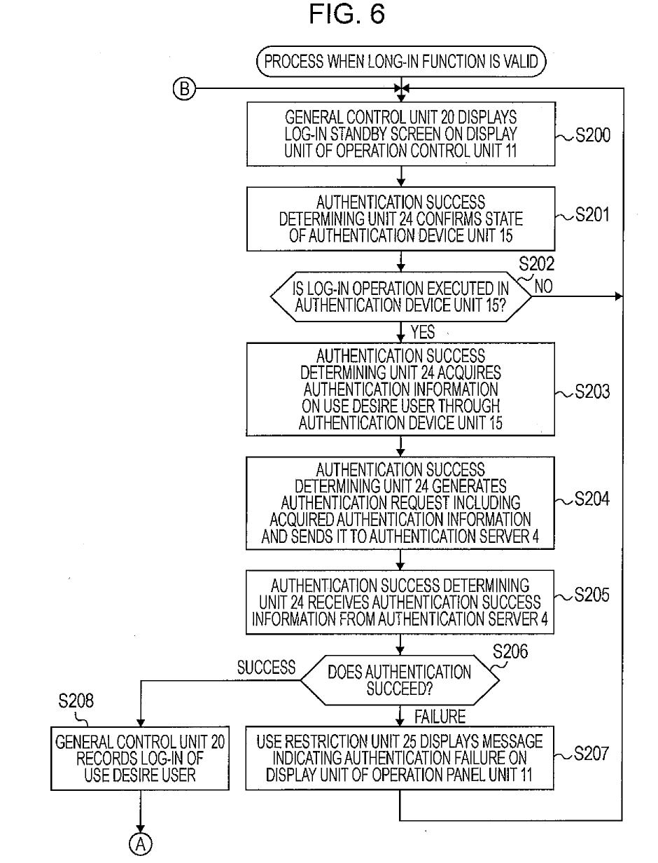

When the general control unit 20 determines that the use restriction function is valid, the process proceeds to a process executed when a log-in function shown in FIG. 6 is valid.

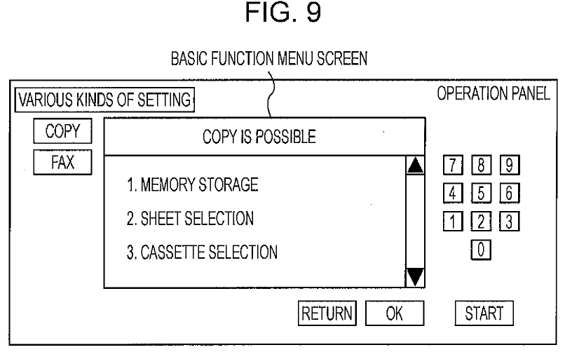

Alternatively, when the general control unit 20 determines that the use restriction function is invalid, the general control unit 20 displays a basic function menu screen for selecting the basic functions on the display unit of the operation panel unit 11 (S102) and waits a panel operation executed by a use desire user (S103). FIG. 9 schematically illustrates an example of the operation panel on which the basic function menu screen is displayed.

When a panel operation executed by the use desire user is detected, the general control unit 20 controls each unit to execute processes (for example, a process of generating and inputting a job in accordance with the panel operation) in accordance with the detected panel operation (S104), like the known example. After the processes end, the process returns to S102.

### Process When Use Restriction Function is Valid

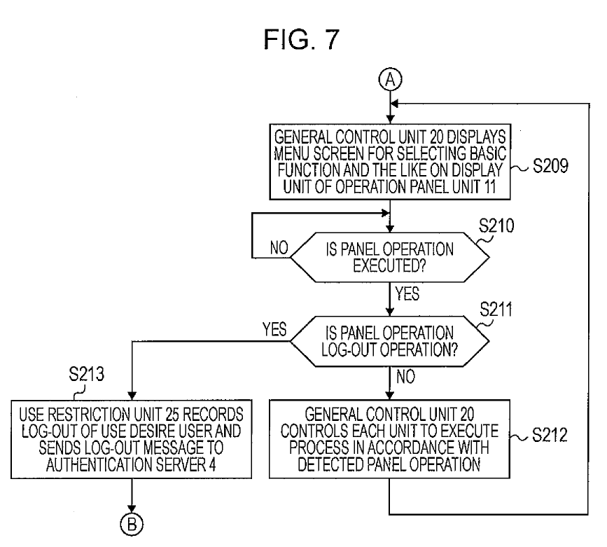

The flowcharts shown in FIGS. 6 and 7 illustrate a process executed when the use restriction function of the multi-function apparatus 1 is valid.

The general control unit 20 displays a log-in standby screen on the display unit of the operation panel unit 11 (S200).

Subsequently, the authentication success determining unit 24 confirms a state of the authentication device unit 15 (S201) and determines whether a log-in operation (for example, an operation of passing a card through the card reader) of the use desire user is executed (S202).

When it is determined that the log-in operation is not executed, the process returns to S201.

Alternatively, when it is determined that the log-in operation is executed, the authentication success determining unit 24 acquires authentication information (for example, card record information read by the card reader) of the use desire user through the authentication device unit 15 (S203).

Subsequently, the authentication success determining unit 24 generates an authentication request including the acquired authentication information and sends the generated authentication request to the authentication server 4 (S204).

When the authentication server 4 receives the authentication request sent from the multi-function apparatus 1, the authentication server 4 executes the authentication process on the basis of the authentication request and replies information on authentication success or failure as a result of the authentication process to the multi-function apparatus 1, like a known example. When the authentication succeeds, the authentication server 4 records and manages the fact that a user corresponding to the authentication information logs in the multi-function apparatus 1.

When the information on authentication success or failure is received as a reply to the authentication request from the authentication server 4 (S205), the authentication success determining unit 24 determines whether authentication succeeds on the basis of the information on authentication success or failure (S206).

When it is determined that the authentication fails, the general control unit 20 displays a message indicating that the authentication fails on the display unit of the operation panel unit 11 (S207). After certain time elapses, the process returns to S200.

Alternatively, when it is determined that the authentication succeeds, the general control unit 20 records information indicating that the use desire user logs in the multi-function apparatus 1 in the memory of the multi-function apparatus 1 (S208). Then, the basic function menu screen for selecting the basic function or the like is displayed on the display unit of the operation panel unit 11 (S209) and the panel operation executed by the use desire user is waited (S210). The basic function menu screen displayed in S209 is the same as that displayed in S102 in principle. In this case, validity (the fact that the use desire user logs in) of the use restriction function may be configured to be expressed by a display of the display unit or a lamp of the operation panel.

When the panel operation executed by the use desire user is detected, the general control unit 20 determines whether the detected panel operation is a log-out operation (S211).

Like the known example, when the detected panel operation is not the log-out operation, the general control unit 20 control each unit to execute a process (for example, a process of generating and inputting a job according to the panel operation) according to the detected panel operation (S212). After the process ends, the process returns to S209.

Alternatively, when the detected panel operation is the log-out operation, the general control unit 20 records information indicating that the use desire user logs out the multi-function apparatus 1 in the memory of the multi-function apparatus 1 and generates a log-out message including the authentication information of the use desire user to transmit the log-out message to the authentication server 4 (S213). Therefore, the process of the multi-function apparatus 1 proceeds to S200.

Like the known example, when the authentication server 4 receives the log-out message transmitted from the multi-function apparatus 1, the authentication server 4 records and manages the fact that a user corresponding to the authentication information contained in the log-out message logs out the multi-function apparatus 1.

### Job Control Process

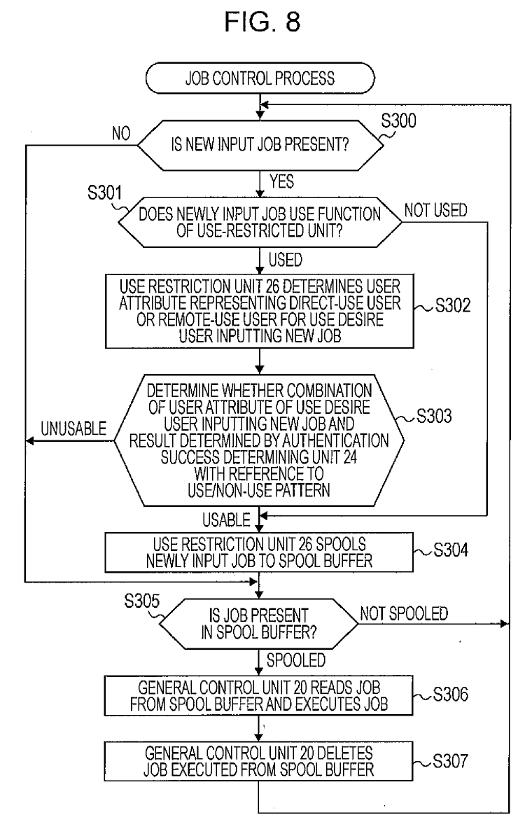

The flowchart illustrated in FIG. 8 describes a job control process of the multi-function apparatus 1. The job control process is executed independently from the process executed when the activation starts or the process executed when the use restriction function is valid, after the process in S100 is executed.

The general control unit 20 determines whether a new job is input to the multi-function apparatus 1 through the operation panel unit 11 or the communication network N (S300).

When it is determined that the new job is not input, the process proceeds to a spool job process.

Alternatively, when it is determined that the new job is input, the use restriction unit 26 determines whether the newly input job is a job for using the function of the use-restricted unit (S301).

When it is determined that the newly input job is the job (for example, a fax reception job or a fax report automatic output job) for not using the function of the use-restricted unit, the process proceeds to S304.

Alternatively, when the newly input job is the job for using the function of the use-restricted unit, the use restriction unit 26 determines the user attribute indicating the direct-use user or the remote-use user for the use desire user having input the new job (S302).

For example, when the new job is a job input through the operation panel unit 11, it is determined that the user attribute indicates the direct-use user. When the new job is a job input from the terminal device 2 through the communication network N, it is determined that the user attribute indicates the remote-use user.

Subsequently, with reference to the information on the use/non-use pattern stored in the RAM in S100, the use restriction unit 26 determines whether the combination of the user attribute of the use desire user having input the new job and the result determined by the authentication success determining unit 24 can be used (S303).

For example, when the use/non-use pattern is the first pattern and only when the user attribute of the use desire user indicates the direct-use user and the authentication success determining unit 24 determines the authentication success with reference to the table shown in FIG. 3A, the use restriction unit 26 determines that the combination can be used.

When the use/non-use pattern is the second pattern and when the user attribute of the use desire user indicates the direct-use user, the authentication success determining unit 24 determines the authentication success with reference to the table shown in FIG. 3B, the use restriction unit 26 determines that the combination can be used. In addition, when the user attribute indicates the remote-use user, the use restriction unit 26 also determines that the combination can be used.

When the use/non-use pattern is the third pattern and when the user attribute of the use desire user indicates the direct-use user or the remote-use user, the restriction unit 26 also determines that the combination can be used with reference to the table shown in FIG. 3C.

Since the user attribute indicates the direct-use user or the remote-use user, the use desire user having input the new job determines that the combination can be normally used in the third pattern. Accordingly, in the case of the third pattern, it can be determined that the combination can be used without referring the table shown in FIG. 3C. When the process proceeds to S303 without executing the process in S206, it is interpreted that the authentication success determining unit 24 does not determine the authentication success. Then, the process of S303 is executed.

When it is determined that the combination cannot be used, the use restriction unit 26 restricts the use desire user having input the new job so as not to use the functions of the use-restricted units. Specifically, the newly input job is controlled not to be spooled in the spool buffer of the memory but to proceed to the spool job process. At this time, when the newly input job is transmitted from the terminal device 2, for example, it is preferable that a message indicating the newly input job cannot be processed is transmitted to the terminal device 2. Likewise, in a case of a job input through the operation panel unit 11, it is preferable that a message indicating that this job cannot be processed is displayed on the display unit of the operation panel.

Alternatively, when it is determined that the combination can be used, the use restriction unit 26 permits the use desire user having input the new job to use the function of the use-restricted unit. Specifically, the newly input job is controlled so as to be spooled in the spool buffer of the memory (S304), and then proceeds to the spool job process.

In the spool job process, the general control unit 20 determines whether a job is spooled in the spool buffer (S305).

When the job is not spooled, the process returns to S300.

Alternatively, when the job is spooled, the general control unit 20 reads the job in a spool order or a job priority order, for example, from the spool buffer and executes the read job by controlling the corresponding unit (S306). For example, When the job is a print job, the general control unit 20 executes a printing process by controlling the printer unit 12, the printing unit 32, and the driver printing unit 34.

When the execution of the read job is completed, the general control unit 20 deletes the job from the spool buffer (S307). Then, the process returns to S300. In addition, when the multi-function apparatus 1 can execute plural jobs in a parallel manner, the process may return to S300 without waiting completion of the jobs.

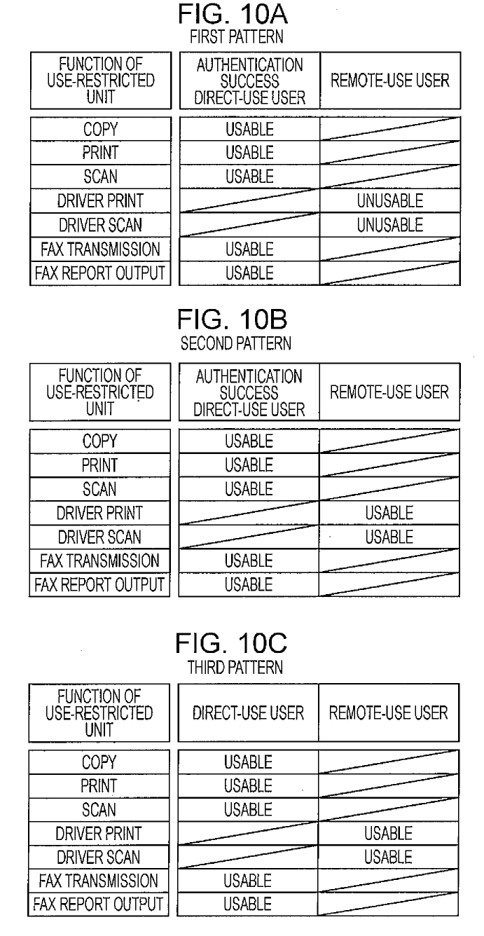

FIGS. 10A to 10C show use and non-use states of the function of each use-restricted unit when each use/non-use pattern is selected. For example, when the first pattern is selected, only the direct-use user succeeding in the user authentication in the multi-function apparatus 1 can use the functions of the use-restricted units. Therefore, the remote-use user cannot use the multi-function apparatus 1. In this case, since the functions such as the functions of the driver printing unit 34 and the driver scanning unit 35 used under the assumption of the remote use cannot be used originally by the direct-use user, these functions cannot be used practically either by the remote-use user or by the direct-use user. Alternatively, when the second pattern is selected, the functions of the driver printing unit 34 and the driver scanning unit 35 are permitted to be used by the remote-use user.

The multi-function apparatus 1 according to this embodiment is configures so that the use or the non-use of the functions of the use-restricted units is set depending on the user attribute indicating the direct-use user or the remote-use user and the use or the non-use of the functions of the use-restricted units for the use desire user is determined on the basis of the user attribute of the use desire user.

With such a configuration, when it is desired that the functions of the use-restricted units are not permitted to be used by the remote-use user regardless of success or failure of the user authentication by the multi-function apparatus 1, these units can be easily realized by configuring the functions of the use-restricted units so as to be used (that is, by selecting the first pattern in this embodiment) only when the user attribute indicates the direct-use user.

When it is desired that the functions of the use-restricted units are permitted to be used without executing the user authentication of the remote-use user by the multi-function apparatus 1, these units can be easily realized by configuring the functions of the use-restricted units so as to be used (that is, by selecting the second or third pattern in this embodiment) when the user attribute indicates the remote-use user.

In the multi-function apparatus 1 according to this embodiment, the use or the non-use of the functions of the use-restricted units can be set in correspondence with the combination of the user attribute and the authentication success/failure state determined by the authentication success determining unit 24.

When it is desired that the functions of the use-restricted units are permitted to be used in the case where user authentication of the direct-use user by the multi-function apparatus 1 succeeds and it is also desired that the functions of the use-restricted units cannot be used by the remote-use user regardless of the success or failure of the user authentication by the multi-function apparatus 1, this operation can be easily realized by configuring the functions of the use-restricted units so as to be used (that is, by selecting the first pattern in this embodiment) when the user attribute indicates the direct-user user and only when the authentication success determining unit 24 determines the authentication success.

When it is desired that the functions of the use-restricted units are permitted to be used in the case where the user authentication of the direct-use user by the multi-function apparatus 1 succeeds and it is also desired that the functions of the use-restricted units are permitted to be used by the remote-use user without executing the user authentication by the multi-function apparatus 1, this operation can be easily realized by configuring the functions of the use-restricted units so as to be used (that is, by selecting the second pattern in this embodiment) when the user attribute indicates the direct-use user and the authentication success determining unit 24 determines the authentication success and when the user attribute indicates the remote-use user.

### Modified Examples

The invention is not limited to the above-described embodiment, but may be modified in various forms. For example, in the above-described embodiment, the multi-function apparatus having the image forming function, the image reading function, and the fax communication function as the basic functions is described. However, the invention is not limited to the multi-function apparatus having these basic functions. For example, even when a multi-function apparatus does not have the image reading function or the fax communication function, the invention can be also applied to a multi-function apparatus having plural printing functions, such as a both-side printing function, a one-side printing function, and a 2UP printing function, as an image forming function. The invention can be also applied to a multi-function apparatus having other functions other than the above functions.

In the above-described embodiment, the authentication success determining unit 24 is configured to determine whether the user authentication succeeds on the basis of the authentication result of the authentication server 4. However, a password or the like of a qualified user are stored in advance in the non-volatile memory of the multi-function apparatus 1 and the authentication success determining unit 24 may determine success or failure of the authentication by comparing the stored passwords of the qualified users to a password input through the operation panel unit 11 from the use desire user.

In the above-described embodiment, the authentication success determining unit 24 is configured to acquire the authentication information by use of the authentication device unit 15. However, the authentication information may be acquired by use of the operation panel unit 11, for example.

In the above-described embodiment, the use or the non-use of the functions of the use-restricted units is set in correspondence with the combination of the user attribute indicating the direct-use user or the remote-use user and the authentication result determined by the authentication success determining unit 24. However, the use or the non-use of the functions of the use-restricted units may be set in correspondence with the user attribute. Alternatively, the use or the non-use of the functions of the use-restricted units may be set in correspondence with combination with another user attribute or the like.

In the above-described embodiment, the first to third patterns are used as the use/non-use pattern. However, the invention is not limited to the three use/non-use patterns, but the type or number of the use/non-use patterns can be determined depending on a design. For example, one of plural use/non-use patterns including the first to third patterns may be selected.

In the above-described embodiment, the options for selecting the use/non-use pattern are configured to be displayed on the display unit of the operation panel unit 11 of the multi-function apparatus 1. However, the options may be displayed on a display unit of an administrator terminal device 2 connected to the multi-function apparatus 1 through a communication network and the use/non-use pattern may be set on the basis of an input process executed through the communication network by the administrator.

In the above-described embodiment, the tables shown in FIGS. 3A to 3C are stored as the information on the use/non-use patterns in advance in the ROM or the like. However, the invention is not limited to this configuration. For example, tables as the information on the use/non-use pattern which show the use/non-use of the functions of the use-restricted units shown in FIGS. 10A to 10C and individually correspond to the use/non-use patterns may be stored as preset tables in advance in the ROM.

When the user attribute of the use desire user having input the new job is not set to be used in the use/non-use pattern in this embodiment, the preset tables define the newly input job as an unrealizable job. Alternatively, when the user attribute of the use desire user having input the new job is set to be used in the use/non-use pattern in this embodiment, the preset tables define the newly input job as a realizable job.

Accordingly, the same configuration as that according to the above-described embodiment can be realized by storing the preset tables in the ROM in advance, configuring so that the use setting unit 25 selects one of the preset tables, and modifying the job control process as follows.

That is, in S302, when it is determined that the newly input job is a job of using the function of the use-restricted unit, the use restriction unit 26 determines whether the newly input job can be executed with reference to information (that is, the preset table showing the use or the non-use of the function of each use-restricted unit) on the use/non-use pattern stored in the RAM in S100. In addition, when the newly input job cannot be executed, the process proceeds to S305. Alternatively, when the newly input job can be executed, the process proceeds to S304.

With such a configuration, it is possible to obtain the same advantages as those according to the above-described embodiment. In addition, since the table showing that each of the functions of the use-restricted units can be executed is selected as the use/non-use pattern, it is not necessary to individually set the use/non-use of every function of the use-restricted units.

The entire disclosure of Japanese Patent Application No. 2008-119928, filed May 1, 2007 is expressly incorporated by reference herein.

What is claimed is:

1. A multi-function apparatus which has plural functions and is used by direct use through an operation panel and remote use through a communication network, the multi-function apparatus comprising:
a use setting unit which sets use or non-use of at least one of functions which the multi-function apparatus has in accordance with a user attribute indicating a direct-use user or a remote-use user; and
a use restriction unit which permits a user desiring to use the at least one of the functions on condition that the user attribute of the user is set to be usable by the use setting unit.

2. The multi-function apparatus according to claim 1, further comprising:
an authentication success determining unit which determines whether authentication succeeds on the basis of authentication information acquired from the user,
wherein the use setting unit selects one of plural patterns including a first pattern used to permit the at least one of the functions to be used only when the user attribute indicates the direct-use user and the authentication success determining unit determines that the authentication succeeds, a second pattern used to permit the at least one of the functions to be used when the user attribute indicates the direct-use user and the authentication success determining unit determines that the authentication succeeds and when the user attribute indicates the remote-use user, and a third pattern used to permit the at least one of the functions to be used when the user attribute indicates the direct-use user or the remote-use user.

3. The multi-function apparatus according to claim 2, wherein the use setting unit displays options used to select one of the plural patterns on a display unit of the multi-function apparatus or a display unit of a terminal device connected to the multi-function apparatus through the communication network, and selects one of the plural patterns on the basis of operation of the user.

4. A method of restricting use of a multi-function apparatus which has plural functions and is used by direct use through an operation panel and remote use through a communication network, the method comprising:
setting use or non-use of at least one of functions which the multi-function apparatus has in accordance with a user attribute indicating a direct-use user or a remote-use user; and
permitting a user desiring to use the at least one of the functions to use the at least some functions on condition that the user attribute of the user is set to be usable in the setting of the use or the non-use.

5. A recording medium recorded a program causing a computer to execute the method according to claim 4.
